(19) United States
(12) Patent Application Publication
(10) Pub. No.: US 2026/0003101 A1
(43) Pub. Date: Jan. 1, 2026

(54) MULTI-MODEL BLENDING VIA A NEURAL NETWORK FOR PROBABILISTIC WEATHER FORECASTS

(71) Applicant: Salient Predictions, Inc., Cambridge, MA (US)

(72) Inventors: Samuel James Levang, Malden, MA (US); Fran Bartolic, New York, NY (US)

(73) Assignee: Salient Predictions, Inc., Cambridge, MA (US)

(21) Appl. No.: 19/251,934

(22) Filed: Jun. 27, 2025

Related U.S. Application Data
(60) Provisional application No. 63/665,629, filed on Jun. 28, 2024.

(51) Int. Cl. G01W 1/10; G06N 3/047

(52) U.S. Cl. CPC G01W 1/10; G06N 3/047

(57) ABSTRACT

Multi-model blending via a neural network for probabilistic weather forecasts is described. A system segments a first training data set into a plurality of second training data sets each including subsets of a first output of a first probabilistic model and a second output of a second probabilistic model. The system modifies, for each of the subsets, weights of a neural network model according to first points of each of the plurality of second training data sets, second points of each of the plurality of second training data sets, and a tuning parameter of the neural network corresponding to the weather condition. The system generates a control parameter indicative of alignment of the neural network model with one or more of the plurality of second training data sets. The system provides the neural network model to generate a weighted output of the first probabilistic model and the second probabilistic model.

### CROSS-REFERENCES TO RELATED APPLICATIONS

This application claims the benefit of priority under 35 U.S.C. § 119 to U.S. Provisional Patent Application No. 63/665,629, filed Jun. 28, 2024, which is hereby incorporated by reference here in its entirety.

### BACKGROUND

It can be technically challenging to accurately predict, and provide advanced notice of, particular climatological events and conditions. For example, with the increase in the likelihood of terrestrial climatological events and conditions beyond expected boundaries, it is both increasingly technically challenging and important to identify weather conditions for a given day with greater advance notice than seven or ten days. However, conventional systems cannot effectively generate accurate estimates of future climatological events and conditions with sufficient accuracy.

### SUMMARY

The technical solutions described herein address technical challenges in achieving reliable, accurate, and well-calibrated probabilistic weather forecasts for extended lead times by adaptively blending outputs from multiple heterogeneous weather models using neural networks. Solutions that utilize static or globally-fixed blending weights often face challenges to fully account for spatial, temporal, and seasonal variability, resulting in decreased forecast accuracy, inconsistencies in probabilistic distributions, and diminished practical utility for decision-making. To overcome such challenges, the neural network-based blending system of the technical solutions employs a machine learning pipeline that segments historical forecast data into feature-specific training sets and learns context-dependent model combination weights based on factors such as location, forecast lead time, and seasonal markers. The trained neural network model can dynamically generate blended probabilistic forecasts tailored to the operational context, while enforcing statistical consistency constraints, thereby improving the skill, coherence, and interpretability of weather forecasts across a broad range of geographic and temporal scenarios.

The technical solutions described herein are directed to a neural network-based solutions for adaptively blending multiple probabilistic weather model outputs to generate accurate and consistent probabilistic weather forecasts for various locations and lead times. Aspects of the solutions relate to a blender model utilizing a machine learning architecture designed to predict weather conditions at specific locations for future times ranging, for example, from two weeks to up to one year ahead. The solutions include training a machine learning model to forecast weather conditions at a given location up to one year in advance. An aspect of these solutions involves using a machine learning pipeline to train and validate a blender model (e.g., a multi-model blending system) to take as input multiple weather model forecasts, and combine them into a single optimal forecast. To do so, the blender model can appropriately weight outputs from multiple probabilistic weather models, ultimately generating a weighted prediction for various geographic locations (such as grid points on a map). This output can represent a probabilistic assessment of the likelihood of certain weather conditions at a location, derived from blending input probabilistic models according to machine-learned weights. As a result, the technical solution of this disclosure offers a technical advancement in producing accurate weather forecasts well beyond two weeks ahead, potentially on a seasonal basis, while remaining applicable for forecasts over shorter lead times from one day to two weeks. Additionally, the machine learning model, according to an aspect of this solution, can be trained to maintain a consistent set of weights corresponding to forecast lead times, geographic details, or seasonal periods. Consequently, this innovation enhances the ability of a machine learning model blending multiple probabilistic weather models to provide accurate forecasts for both long-range and shorter-range scenarios.

In some cases, the system can implement a single global blending model using a neural network architecture. This neural network receives, as inputs, the spatial and temporal coordinates in addition to other predictive features relevant to the forecasting process. The neural network is trained to output the blending weights at each grid point based on these input features. As a result, this approach enables the blending weights to vary in a non-linear manner for each forecast instance, thereby allowing the model to dynamically assign higher or lower weighting to individual constituent models in response to prevailing weather conditions or other relevant factors.

At least one aspect of the technical solutions described herein can be directed to a system. The system can include one or more processors, coupled with memory. The system can segment a first training data set into a plurality of second training data sets each can include subsets of a first output of a first probabilistic model and a second output of a second probabilistic model, the first output can include a first forecast indicative of a weather condition, and the second output can include a second forecast indicative of the weather condition. The system can provide, to a neural network model, a first point of each of the plurality of second training data sets and a second point of each of the plurality of second training data sets, the first point indicative of the weather condition at a location, and the second point indicative of the weather condition at a time corresponding to the location. The system can modify, for each of the subsets, one or more weights of a neural network model according to the one or more first points, the one or more second points, and a tuning parameter of the neural network corresponding to the weather condition. The system can generate a control parameter indicative of alignment of the neural network model with one or more of the plurality of second training data sets. The system can provide, responsive to the control parameter satisfying a threshold indicative of a level of alignment with the plurality of second training data sets, the neural network model trained to generate, according to the one or more weights, a weighted output of the first probabilistic model and the second probabilistic model at the first point and the second point.

At least one aspect of the technical solutions described herein can be directed to a system. The system can include one or more processors, coupled with memory. The system can obtain a runtime data set can include a first output of a first probabilistic model and a second output of a second probabilistic model, the first output can include a first forecast indicative of the weather condition, and the second output can include a second forecast indicative of the weather condition. The system can generate, according to a neural network model having one or more weights and receiving as input the runtime data set and configured according to a tuning parameter of the neural network corresponding to the weather condition, a weighted output of the first probabilistic model and the second probabilistic model at a first target point indicative of a location and a second target point indicative of a time corresponding to the location, where the one or more weights each correspond to one or more first training points corresponding to the first target point and one or more second training points corresponding to the second target point, each of the first training points indicative of the weather condition at one or more corresponding locations, and each of the one or more second training points indicative of the weather condition at one or more corresponding times.

At least one aspect of the technical solutions described herein can be directed to a method. The method can include segmenting a first training data set into a plurality of second training data sets each can include subsets of a first output of a first probabilistic model and a second output of a second probabilistic model, the first output can include a first forecast indicative of a weather condition, and the second output can include a second forecast indicative of the weather condition. The method can include providing, to a neural network model, a first point of each of the plurality of second training data sets and a second point of each of the plurality of second training data sets, the first point indicative of the weather condition at a location, and the second point indicative of the weather condition at a time corresponding to the location. The method can include modifying, for each of the subsets, one or more weights of a neural network model according to the one or more first points, the one or more second points, and a tuning parameter of the neural network corresponding to the weather condition. The method can include generating a control parameter indicative of alignment of the neural network model with one or more of the plurality of second training data sets. The method can include providing, responsive to the control parameter satisfying a threshold indicative of a level of alignment with the plurality of second training data sets, the neural network model trained to generate, according to the one or more weights, a weighted output of the first probabilistic model and the second probabilistic model at the first point and the second point.

At least one aspect of the technical solutions described herein can be directed to a method. The method can include obtaining a runtime data set can include a first output of a first probabilistic model and a second output of a second probabilistic model, the first output can include a first forecast indicative of the weather condition, and the second output can include a second forecast indicative of the weather condition. The method can include generating, according to a neural network model having one or more weights and receiving as input the runtime data set and configured according to a tuning parameter of the neural network corresponding to the weather condition, a weighted output of the first probabilistic model and the second probabilistic model at a first target point indicative of a location and a second target point indicative of a time corresponding to the location, where the one or more weights each correspond to one or more first training points corresponding to the first target point and one or more second training points corresponding to the second target point, each of the first training points indicative of the weather condition at one or more corresponding locations, and each of the one or more second training points indicative of the weather condition at one or more corresponding times.

At least one aspect can be directed to a non-transitory computer-readable medium storing processor executable instructions that, when executed by one or more processors, cause the one or more processors to perform the methods described herein.

### BRIEF DESCRIPTION OF THE FIGURES

These and other aspects and features of the present implementations are depicted by way of example in the figures discussed herein. Present implementations can be directed to, but are not limited to, examples depicted in the figures discussed herein. Thus, this disclosure is not limited to any figure or portion thereof depicted or referenced herein, or any aspect described herein with respect to any figures depicted or referenced herein.

FIG. 1 depicts an example system, according to this disclosure.

FIG. 2 depicts an example flow architecture, according to this disclosure.

FIG. 3 depicts an example method of multi-model blending via a neural network for probabilistic weather forecasts, according to this disclosure.

FIG. 4 depicts an example method of multi-model blending via a neural network for probabilistic weather forecasts, according to this disclosure.

FIG. 5 depicts an example method of multi-model blending via a neural network for probabilistic weather forecasts, according to this disclosure.

### DETAILED DESCRIPTION

Aspects of the technical solutions are described herein with reference to the figures, which are illustrative examples of this technical solution. The figures and examples below are not meant to limit the scope of this technical solution to the present implementations or to a single implementation, and other implementations in accordance with present implementations are possible, for example, by way of interchange of some or all of the described or illustrated elements. Where certain elements of the present implementations can be partially or fully implemented using known components, only those portions of such known components that are necessary for an understanding of the present implementations are described, and detailed descriptions of other portions of such known components are omitted to not obscure the present implementations. Terms in the specification and claims are to be ascribed no uncommon or special meaning unless explicitly set forth herein. Further, this technical solution and the present implementations encompass present and future known equivalents to the known components referred to herein by way of description, illustration, or example.

Weather forecasting for extended lead times, including monthly, seasonal, and year-ahead predictions, can present technical challenges with respect to forecast skill, calibration, and the representation of uncertainty across diverse geographical areas and evolving climate phenomena. Integrating multiple probabilistic weather models can expose limitations of various aggregation approaches, such as the use of static or spatially invariant blending weights, which may not account for variations in location, forecast lead time, or seasonal context. These constraints can diminish the accuracy and robustness of the resulting forecasts, lead to inconsistent outputs (such as illogical probability distributions or quantile crossings), and undermine the overall utility of probabilistic predictions for weather-sensitive decision making. Consequently, it can be beneficial to provide a technical solution that can adaptively combine forecasts from heterogeneous models in a manner that is responsive to relevant features, such as spatial coordinates, time, and weather regime, while also providing the desired statistical coherence of the resultant predictive distribution.

The technical solutions of this disclosure address these challenges by providing a neural network-based blending system designed to produce enhanced probabilistic weather forecasts over a range of lead times and geographical settings. The disclosed approach can utilize a machine learning pipeline that organizes historical forecast data from multiple constituent probabilistic models into feature-specific training segments, allowing the neural network blender model to assign context-dependent blending weights to each model according to relevant forecast attributes, including location, target lead time, and seasonal markers. During model training, the neural network can adaptively adjust or optimize the blending weights for each grid point and forecasting context, with the objective of maximizing forecast skill as quantified by a loss metric, and while also enforcing statistical consistency constraints such as quantile non-crossing and weight normalization. As a result, the trained neural network can dynamically process real-time probabilistic model outputs, generating an aggregate probabilistic forecast tailored to the specified location and time horizon, and thereby advancing the accuracy, interpretability, and applicability of long-range and short-term probabilistic weather prediction.

Aspects of this disclosure are directed to a blender model having a neural network architecture and configured to generate a forecast of a weather condition at a given location at a future time between two weeks and one year from a forecast point. For example, the forecast point can correspond to a present time. Thus, aspects of the technical solutions described herein can include a neural network model trained to generate a forecast of a weather condition at a given location up to one year in advance. In an aspect, the technical solutions can train a blender model using neural network to weight output of a plurality of probabilistic weather models, and to generate a weighted output of each of the probabilistic weather models with respect to various locations (e.g., grid points) of a geographical area (e.g., world map). The output can correspond to a probabilistic determination of likelihood of the weather condition at the location, based on the blending of the input probabilistic models according to the weights assigned by training via neural network for a given location. Thus, this technical solution can provide at least a technical improvement to generate accurate forecasts of weather conditions on a future date greater than two weeks in advance (e.g., from one month in advance to a year in advance), including on a seasonal basis. However, this technical solution is not limited to weather forecasting from two weeks in advance, and can provide a weather forecast at least as discussed herein for a lead time of one day or greater in advance (e.g., between one day and two week or fourteen days). In an aspect, a neural network model can be trained according to this technical solution to have distinct or unique weights for a given forecast lead time, latitude, longitude, or season. For example, a forecast configured for January of a given first year, associated with the El Niño weather phenomenon, includes different weights from a forecast configured for January of a given second year not associated with El Niño, where January corresponds to a given season within a year. Thus, this technical solution can provide a technical improvement to increase granularity or precision of long-range weather forecasts in which a neural network model, that blends a plurality of probabilistic weather models, can deliver accurate long-range or short-range (e.g., less than two week or fourteen days) forecasts.

In an example, the technology described herein provides a system that includes or utilizes a blending model. The system can include or be implemented using one or more processors coupled with memory. The memory can store instructions for performing various operations of the system. For instance, the system can provide, include or implement a blending model which can be configured to use probabilistic forecasts from constituent models (e.g., multiple weather model forecasts). These constituent models can be presented in various formats, such as for example: (a) discrete trajectories of weather properties through perturbed ensemble member runs, sourced from Numerical Weather Prediction models or machine-learning-based weather emulator models, and (b) probabilistic representations from statistical or machine learning-type weather models, formatted as a quantile function (QF), cumulative distribution function (CDF), or probability distribution function (PDF). The system can standardize the model outputs into a common format, such as a quantile function or a set of categorical bins, for training purposes.

To create the training dataset, the system can combine historical forecasts from each constituent model with corresponding truth data for the target weather property. The system can introduce each forecast to the blending model as a training sample, and the model undergoes training by adjusting the weights of the model to minimize a pre-selected loss function. The system can employ a gradient descent algorithm for the purposes of training, which can iteratively adjust weights for each mini-batch of forecast samples. The system can repeat this process over multiple cycles, or epochs, until the system does not observe any further decrease in the loss metric on an out-of-sample validation dataset.

The system can optimize the blending model to enhance probabilistic performance metrics, such as the Continuous Ranked Probability Score (CRPS) for continuous scales or Binary Cross Entropy (BCE) for discrete categories. The process executed by the system can facilitate maintaining the consistency of the blended forecast, such as by avoiding quantile crossings and normalizing weights to sum to one.

The system can generate numerical weights for each constituent forecast model. These values can collectively sum to one. In some cases, the system uses constant weights over time, while allowing these weights to vary by spatial grid point, forecast lead time, and season. The training process optimizes the weights under these conditions.

The system performs cross-validation to improve the model training and validation sequence. For example, a training set can be generated for each constituent model, utilizing cross-validated out-of-sample reforecast data for statistical or machine learning models and available reforecast data for physically-based numerical weather prediction models. This dataset can be further divided into training and validation sets in a k-fold scheme, allowing individual model training for each fold. These fold models then collectively produce a blended out-of-sample reforecast across the entire training dataset for validation. An additional separate test period is withheld from all training folds, preserving an extra independent out-of-sample set throughout cross-validation.

Thus, the system can provide an operational version of the model in a production system by storing the trained model weights. To do so, the system can construct a similar pipeline of real-time constituent model forecast inputs to be processed by the trained model for ongoing predictions.

Technical advantages of the technology described herein include the capability to accept probabilistic forecast models as inputs and, in turn, generate an optimized probabilistic blended forecast. This allows the technical solution described herein to accurately represent forecast uncertainty for sub-seasonal to seasonal (S2S) timescales, thereby enhancing the usability of the forecast for a wide range of decision-making applications.

Another technical advantage of aspects of the technical solutions described herein relates to the ability of the technical solution to assign independent weights to each constituent model in accordance with their variable historical accuracy, which may depend on forecast lead time, spatial location, and prevailing climate state. By dynamically adjusting the model weights in response to these factors, aspects of the technical solutions described herein can achieves superior forecast accuracy and performance compared to approaches that rely on fixed constituent model weights.

Yet another technical advantage of aspects of the technical solutions described herein relate to providing a rigorous cross-validation protocol designed to maximize the available out-of-sample validation data for model evaluation. This methodology generates reliable information regarding the conditions under which the blended forecasting model exhibits strong accuracy and performance, thereby supporting more informed weather-related decision-making, action generation, and operations.

In some cases, the system can implement a single global blending model using a neural network architecture. This neural network receives, as inputs, the spatial and temporal coordinates in addition to other predictive features relevant to the forecasting process. The neural network is trained to output the blending weights at each grid point based on these input features. As a result, this approach enables the blending weights to vary in a non-linear manner for each forecast instance, thereby allowing the model to dynamically assign higher or lower weighting to individual constituent models in response to prevailing weather conditions or other relevant factors.

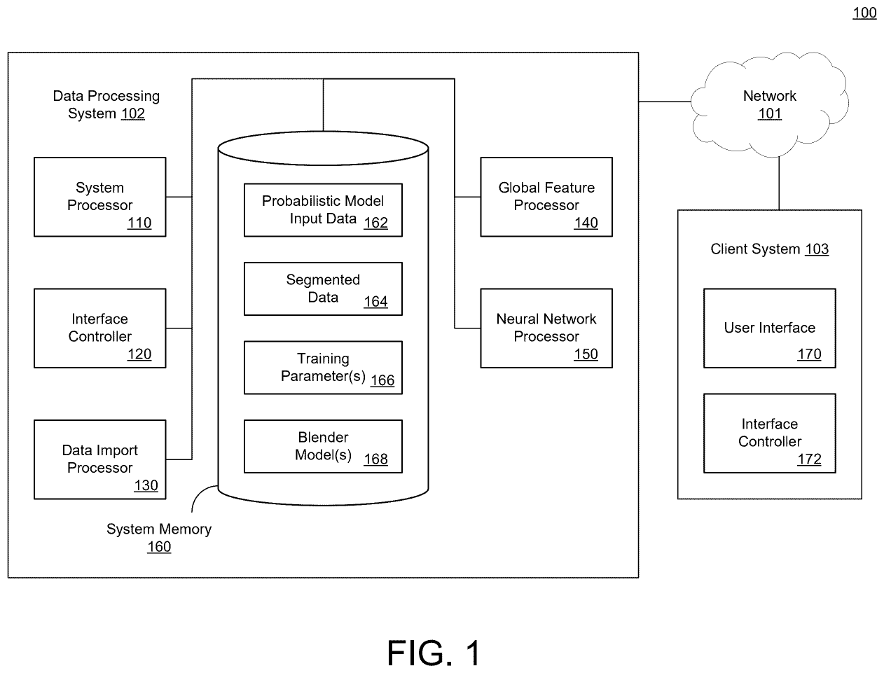

FIG. 1 depicts an example system, according to this disclosure. As illustrated by way of example in FIG. 1, a system 100 can include at least a network 101, a data processing system 102, and a client system 103. The client system 103 can include a user interface 170, and an interface controller 172. For example, the interface controller 172 can effect communication with the data processing system 102 via the interface controller 120. For example, the user interface 170 can present graphical user interface elements corresponding to output of a blender model as discussed herein. For example, the user interface 170 can present graphical user interface elements compositing or overlaying output of a plurality of blender models as discussed herein.

The network 101 can include any type or form of network. The geographical scope of the network 101 can vary widely and the network 101 can include a body area network (BAN), a personal area network (PAN), a local-area network (LAN), e.g. Intranet, a metropolitan area network (MAN), a wide area network (WAN), or the Internet. The topology of the network 101 can be of any form and can include, e.g., any of the following: point-to-point, bus, star, ring, mesh, or tree. The network 101 can include an overlay network which is virtual and sits on top of one or more layers of other networks 101. The network 101 can be of any such network topology as known to those ordinarily skilled in the art capable of supporting the operations described herein. The network 101 can utilize different techniques and layers or stacks of protocols, including, e.g., the Ethernet protocol, the Internet protocol suite (TCP/IP), the ATM (Asynchronous Transfer Mode) technique, the SONET (Synchronous Optical Networking) protocol, or the SD (Synchronous Digital Hierarchy) protocol. The TCP/IP Internet protocol suite can include application layer, transport layer, Internet layer (including, e.g., IPv6), or the link layer. The network 101 can include a type of a broadcast network, a telecommunications network, a data communication network, or a computer network.

The data processing system 102 can include a physical computer system operatively coupled or that can be coupled with one or more components of the system 100, either directly or directly through an intermediate computing device or system. The data processing system 102 can include a virtual computing system, an operating system, and a communication bus to effect communication and processing. The data processing system 102 can include a system processor 110, an interface controller 112, a data import processor 130, a global feature processor 140, a neural network processor 150, and a system memory 160.

The system processor 110 can execute one or more instructions associated with the system 100. The system processor 110 can include an electronic processor, an integrated circuit, or the like including one or more of digital logic, analog logic, digital sensors, analog sensors, communication buses, volatile memory, nonvolatile memory, and the like. The system processor 110 can include, but is not limited to, at least one microcontroller unit (MCU), microprocessor unit (MPU), central processing unit (CPU), graphics processing unit (GPU), physics processing unit (PPU), embedded controller (EC), or the like. The system processor 110 can include a memory operable to store or storing one or more instructions for operating components of the system processor 110 and operating components operably coupled to the system processor 110. For example, the one or more instructions can include one or more of firmware, software, hardware, operating systems, embedded operating systems. The system processor 110 or the system 100 generally can include one or more communication bus controller to effect communication between the system processor 110 and the other elements of the system 100.

The data import processor 130 can the interface controller 120. For example, the data import processor 130 can obtain one or more data sets and can generate one or more subsets are discussed herein. For example, the data import processor 130 can include one or more data processing or preprocessing components to identify a target property and to generate, modify, restructure, or any combination thereof, a data set from a probabilistic model to be compatible with a neural network system, including, but not limited to, the global feature processor 140. For example, the data import processor 130 can provide one or more correlated data subsets to the global feature processor 140 or the neural network processor 150. In an aspect, the system can correlate, into the first training data set, a third output corresponding to ground truth for the weather condition, the third output can include one or more values of a target property corresponding to a feature of the neural network model.

The data import processor 130 can be structured to segment a first training data set that can include outputs from multiple probabilistic weather models into a plurality of second training data sets. Each second training data set can include subsets comprising a first output from a first probabilistic model and a second output from a second probabilistic model, where the first output can include a forecast indicative of a weather condition and the second output can include a separate forecast indicative of the same weather condition. For example, the data import processor 130 can receive historical forecasts from both a numerical weather prediction model and a statistical weather model, and can identify overlapping grid points by location and corresponding forecast times. The processor can group these paired outputs into structured subsets, such that each subset can include the weather predictions for a specific location and time from both models. For instance, the data import processor 130 can reformat each model's output into a standard probabilistic format, such as quantile functions or cumulative distribution functions, before segmentation. This can allow for consistent and harmonized subsets to be created across varying model architectures. Such segmentation can facilitate the creation of feature-aligned and context-specific training data for use by the neural network processor 150 in forecasting weather conditions.

The global feature processor 140 can select and provide one or more parameters to the neural network processor 150 that correspond to a target property for blending of a plurality of probabilistic models as discussed herein. For example, the global feature processor 140 can identify that a target property corresponds to a given feature in the data set input or the correlated subsets of the data set input. In response, the global feature processor 140 can obtain or select at one of a control parameter and a consistency property corresponding to the target property. For example, the global feature processor 140 can identify a feature for a target property corresponding to a daily high temperature, and can select a control parameter indicative of a threshold of alignment with a temperature value. For example, the threshold of alignment can correspond to a maximum permissible deviation (e.g., 0.50%), but is not limited thereto.

The neural network processor 150 can include or execute an operation to train a neural network model, or execute a trained neural network model. For example, the neural network processor 150 can obtain one or more data sets or correlated subsets from the data import processor 130. For example, the neural network processor 150 can obtain one or more features or properties based on a selection or identification of the features or properties by the global feature processor 140. In an aspect, the neural network processor 150 is structured to receive input data and input features structured according to one or more probabilistic models or type of probabilistic models. In an aspect, the neural network processor 150 is structured to generate, by the trained neural network model, a probabilistic output for a target property, where the target property is a target feature among a plurality of features structured according to one or more probabilistic models or type of probabilistic models at least as discussed herein.

The neural network processor 150 can be structured to receive, as input, data from each of the plurality of second training data sets that have been segmented by the data import processor 130. The neural network processor 150 can provide, to the neural network model, a first point from each of these second training data sets and a second point from each, where the first point can be indicative of the weather condition at a particular location, and the second point can be indicative of the weather condition at a corresponding time for that location. For example, the neural network processor 150 can extract, from each structured subset, values representing the predicted weather variable at a specific spatial coordinate for the first point, and at a particular forecast lead time or timestamp for the second point. For instance, the neural network processor 150 can prepare input feature vectors for the neural network model such that each input pair reflects a mapping of location and time to the respective predicted weather condition from the relevant probabilistic models.

The neural network processor 150 can be structured to modify, for each subset within the plurality of second training data sets, one or more weights of the neural network model based on the one or more first points, the one or more second points, and a tuning parameter corresponding to the weather condition. For example, the neural network processor 150 can process each input subset to determine weight adjustments that reflect the spatial and temporal characteristics indicated by the first and second points. The tuning parameter can relate to properties such as location, forecast lead time, or season associated with the weather condition, and can be used by the neural network processor 150 to further guide the modification of weights within the model. For instance, the neural network processor 150 can train the neural network to assign distinct blending weights to each probabilistic model depending on the input features, so that the network adapts to specific contextual cues provided by the segmented training data. This can facilitate the adaptive weighting of input model forecasts in response to changes in location, time, or other relevant conditions during the training process.

The neural network processor 150 can be configured to generate a control parameter that is indicative of the alignment of the neural network model with one or more of the plurality of second training data sets. For example, during the training process, the neural network processor 150 can evaluate the accuracy or calibration of the neural network model by comparing the model's output to reference data within the training subsets. The control parameter can reflect metrics such as a loss value, probability score, or other measure of forecast agreement, which can be calculated for individual subsets or across multiple subsets. For instance, the neural network processor 150 can compute the continuous ranked probability score or cross-entropy to assess how well the blended output of the neural network model matches the observed weather outcomes or held-out validation data.

The neural network processor 150 can be structured to provide the neural network model, trained to generate a weighted output of the first probabilistic model and the second probabilistic model at the first point and the second point, when the control parameter satisfies a threshold indicative of a desired level of alignment with the plurality of second training data sets. For example, the neural network processor 150 can monitor the control parameter during training to determine whether the model's performance meets a predefined criterion for forecast accuracy or probabilistic consistency. When this threshold is reached, the neural network processor 150 can finalize and provide the trained neural network model. For any given input location and time, the model can then combine outputs from the first and second probabilistic models according to the learned weights. For instance, the neural network processor 150 can allow the trained model to produce a single blended probabilistic forecast by appropriately weighting the predictions from the constituent models, such as for example, based on the learned relationships between the first and second points.

The neural network processor 150 can be structured to obtain a runtime data set that can include a first output from a first probabilistic model and a second output from a second probabilistic model. The first output can include a first forecast that is indicative of a weather condition, such as a predicted temperature or precipitation value for a specific location and time. The second output can include a second forecast, also indicative of the same weather condition, but generated by a different probabilistic model. For example, during operational use, the neural network processor 150 can receive current forecast data from both a numerical weather prediction model and a statistical weather model. The processor can organize these model outputs such that both sets of forecasts correspond to the same grid point and forecast lead time. This can allow for direct comparison or blending of probabilistic information from each model.

The neural network processor 150 can be structured to generate a weighted output from the first probabilistic model and the second probabilistic model, using a neural network model that has one or more weights and receives the runtime data set as input. The neural network model can be configured according to a tuning parameter that corresponds to the weather condition being predicted. For instance, the processor can input data representing forecasts from both models for a specific location and forecast time into the neural network model. The model can then apply the learned weights, which may be adjusted by the tuning parameter based on factors such as location, lead time, or season. As a result, the neural network processor 150 can produce a single blended forecast output where the contribution from each probabilistic model reflects the contextual relevance of that model for the specific target location and time.

The neural network processor 150 can be structured so that the one or more weights of the neural network model, each correspond to one or more first training points and one or more second training points. Each first training point can be indicative of the weather condition at one or more locations related to the first target point. Each second training point can be indicative of the weather condition at one or more times related to the second target point. For example, the neural network processor 150 can use training data where each weight is informed by how previous weather forecasts performed across different locations and forecast lead times. This can allow the neural network model to assign weights that are sensitive to both spatial and temporal features of the modeling, improving the accuracy of the model's blended forecasts.

The system memory 160 can store data associated with the system 100. The system memory 160 can include one or more hardware memory devices to store binary data, digital data, or the like. The system memory 160 can include one or more electrical components, electronic components, programmable electronic components, reprogrammable electronic components, integrated circuits, semiconductor devices, flip flops, arithmetic units, or the like. The system memory 160 can include at least one of a non-volatile memory device, a solid-state memory device, a flash memory device, or a NAND memory device. The system memory 160 can include one or more addressable memory regions disposed on one or more physical memory arrays. A physical memory array can include a NAND gate array disposed on, for example, at least one of a particular semiconductor device, integrated circuit device, and printed circuit board device. The system memory 160 can include a probabilistic model input data 162, a segmented data 164, training parameters 166, and blender models 168. At least as discussed herein, the system memory 160 can correspond to a computer readable medium including one or more instructions to execute one or more

The probabilistic model input data storage 162 can store the data set as discussed herein. For example, the probabilistic model input data storage 162 is not limited to any given type or number, and can store input data corresponding to a plurality of target properties at least as discussed herein (e.g., daily high temperature, daily low temperature, humidity, frost, extreme weather events). Thus, the probabilistic model input data storage 162 can support determination of a plurality of target properties as discussed herein. For example, the probabilistic model input data storage 162 can store or buffer live data corresponding to output from one or more probabilistic models. The segmented data storage 164 can store correlated subsets of the data set as discussed herein. For example, the segmented data storage 164 is not limited to any given type or number, and can store input data or correlated subsets corresponding to a plurality of target properties at least as discussed herein. Thus, the segmented data storage 164 can support determination of a plurality of target properties as discussed herein. For example, the segmented data storage 164 can store or buffer correlated subsets of live data corresponding to output from one or more probabilistic models.

The training parameters storage 166 can store one or more parameters associated with training a neural network model according to probabilistic input data as discussed herein. For example, the training parameters storage 166 can store one or more control parameters and one or more consistency properties as discussed herein. The blender models storage 168 can store one or more blender models as discussed herein. For example, a blender model corresponds to a trained neural network model as discussed herein. The blender models storage 168 can store a plurality of blender models each corresponding to a respective target property. For example, the blender models storage 168 can store a first blender model corresponding to forecasting a daily high temperature six months in advance, a second blender model corresponding to forecasting a daily low temperature six months in advance, and a third blender model corresponding to forecasting a daily humidity six months in advance. The blender models storage 168 can store a plurality of blender models each corresponding to a respective set of probabilistic models. For example, each blender model can be trained on or operate to generate live data on varying subsets of available probabilistic model input. For example, a first blender model can include National Oceanic and Atmospheric Administration (NOAA) data, and a second blender model can exclude NOAA data.

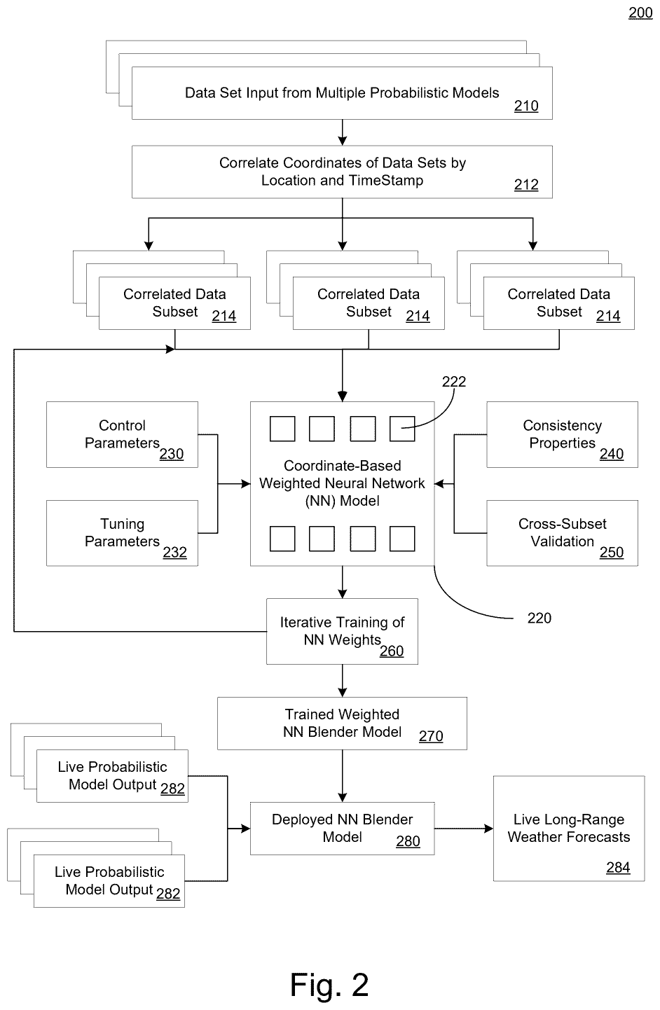

FIG. 2 depicts an example flow architecture, according to this disclosure. As illustrated by way of example in FIG. 2, a flow architecture 200 can include at least data set input from multiple probabilistic models 210, correlated data subsets 214, a correlate coordinates of data sets by location and timestamp 220, a coordinate-based weighted neural network (NN) model 220, control parameters 230, tuning parameters 232, consistency properties 240, a cross-subset validation 250, an iterative training of NN weights 260, a trained weighted NN blender model 270, a deployed NN blender model 280, live probabilistic model outputs 282, and live long-range weather forecasts 284.

The data set input from multiple probabilistic models 210 can correspond to output of multiple probabilistic models as discussed herein. For example, the data set input from multiple probabilistic models 210 can include output of at least a first probabilistic model and a second probabilistic model. In an aspect, the first probabilistic model has a first probabilistic configuration, and the second probabilistic model has a second probabilistic configuration distinct from the first probabilistic configuration. In an aspect, the first probabilistic model corresponds to at least one of a numerical weather prediction model, a weather emulator model, or a statistical weather model. In an aspect, the second probabilistic model corresponds to at least one of a numerical weather prediction model, a weather emulator model, or a statistical weather model. In an aspect, the first probabilistic model generates output structured according to at least one of a quantile, a cumulative distribution, or a probability distribution. In an aspect, the second probabilistic model generates output structured according to at least one of a quantile, a cumulative distribution, or a probability distribution. In an aspect, the first probabilistic model corresponds to at least one of a numerical weather prediction model, a weather emulator model, or a statistical weather model, and the second probabilistic model corresponds to at least one of the numerical weather prediction model, the weather emulator model, or the statistical weather model.

The correlated data subsets 214 can each correspond to a correlated subset of data input from a probabilistic model, at least as discussed herein. In an aspect, the system can correlate, into the first training data set, a third output corresponding to ground truth for the weather condition, the third output can include one or more values indicative of the weather condition. For example, the data import processor 130 can correlate coordinates of data sets 212 by location and timestamp. The correlating coordinates of data sets 212 by location and timestamp can include use of NN model weights 222.

The neural network processor 150 can generate or train the coordinate-based weighted neural network (NN) model 220. The coordinate-based weighted NN model 220 can include NN model weights 222. In an aspect, the neural network processor 150 can modify, for each of the subsets, the one or more NN model weights 222 independently with respect to a plurality of weather properties each indicative of corresponding physical properties, where the weather properties each correspond to at least one of location, forecast lead time, or season. For example, each of the NN model weights 222 can correspond to weights between neurons of the neural network processor 150. The neural network processor 150 can include multiple hidden layers of neurons, and neurons have many-to-many connections with each other. For example, each of the neurons of the coordinate-based weighted NN model 220 can be associated with a given grid point or plurality of grid points of a physical model. For example, a physical model can correspond to a world map including a plurality coordinates each associated with a specific location (e.g., latitude and longitude) within the world map. Each of the grid points can correspond to a coordinate of the world map at a given granularity in latitude and longitude. For example, various neurons of the coordinate-based weighted NN model 220 can be associated with various grid points, and can provide, either individually or collectively, a weighted blend of a plurality of probabilistic models at each grid point to maximize accuracy of long-rage weather forecasts at each grid point.

In an aspect, the system can determine that the control parameter satisfies the threshold according to a target property indicative of the weather condition, the target property corresponding to a feature of the neural network model. The control parameters 230 can include a control parameter as discussed herein, and can be obtained from the training parameters storage 166. In an aspect, a control parameter can be seasonally adjusted, to align with values or features of weather-related probabilistic data according to segments associated with seasons. For example, a control parameter can have a first value or range of values for timestamps aligned with one or more predetermined summer months, and a second value or range of values for timestamps aligned with one or more predetermined winter months. For example, a control parameter can have a first value or range of values for timestamps aligned with one or more detected local maxima (e.g., values indicative of summer months), and a second value or range of values for timestamps aligned with one or more detected local minima (e.g., values indicative of winter months). In an aspect, the one or more weights are provided responsive to a control parameter satisfying a threshold indicative of a level of alignment with a training data set can include the one or more first training points and the one or more second training points.

In an aspect, the tuning parameter is configured to modify at least one weight of at least one connection between a first neuron and a second neuron, based at least partially on a relative weight of one or more probabilistic models provided as input to at least one of the first neuron or the second neuron. For example, a relative weight can correspond to a difference between weights applied to each of a plurality of probabilistic models with respect to a given grid point (or plurality of grid points) associated with a neuron. The tuning parameters 232 can include a tuning parameter as discussed herein, and can be obtained from the training parameters storage 166. In an aspect, a tuning parameter can correspond to a scaling factor or gain associated with a given neuron or NN weight 222. For example, the tuning parameter can correspond to a linear or nonlinear gain that is based on a relative contribution of one or more probabilistic models to a given grid point or set of grid points (e.g., adjacent grid points or a plurality of grid points within a predetermined distance of a selected grid point or centroid of grid points). For example, the neural network processor 220 can associate different tuning parameters having differing scaling factors, different linear gains, or different nonlinear gains to various neurons or connections between neurons. Thus, the tuning parameters can provide a technical solution to accurately configure a neural network that receives a plurality of probabilistic data sets to generate long-ranger weather forecasts accurately and precisely with respect to a particular grid point at a particular forecast time up to one year in advance. In an aspect, the tuning parameter corresponds to at least one of location, forecast lead time, or season, and the weather condition corresponds to a forecast lead time greater than two weeks. For example, the tuning parameters can be associated with a given weather phenomenon or weather event. In an aspect, a weather phenomenon includes a pattern of weather or modification to weather that is associated with a period greater than a short-range forecast of 1-14 days. For example, a weather phenomenon can include El Niño, La Niña, hurricane season (formation or transit), or any combination thereof, but is not limited thereto. In an aspect, a weather event includes a pattern of weather or modification to weather that is associated with a period corresponding to or less than a short-range forecast of 1-14 days. For example, a weather event can include a nor-easter, a sou-wester, hurricane landfall, a tornado touchdown, a derecho, or any combination thereof, but it not limited thereto. Thus, in an aspect, the tuning parameter can modify one or more weights of the neural network model corresponding to one or more grid points to increase accuracy of long-range forecasting of a target property corresponding to a weather condition, in view of specific weather phenomena or weather events. For example, the tuning parameter can modify one or more weights of the neural network model corresponding to one or more grid points, according to a profile of weight modifiers associated with a given weather phenomenon or weather condition.

The consistency properties 240 can include a consistency property as discussed herein, and can be obtain from the training parameters storage 166. In an aspect, the one or more consistency properties constrain modification of the one or more weights for each of the subsets. In an aspect, the consistency properties are structured to enforce non-crossing of quantile levels. In an aspect, the consistency properties are structured to enforce normalization of each of the one or more weights to aggregate to a predetermined scalar value. In an aspect, the consistency properties are structured to enforce non-crossing of quantile levels. In an aspect, the consistency properties are structured to enforce normalization of each of the one or more weights to aggregate to a predetermined scalar value. In an aspect, the one or more consistency properties constrain modification of the one or more weights for each of the subsets.

The NN model 220 can perform cross-subset validation 250. For example, the neural network processor 150 can validate the coordinate-based weighted NN model 220 according to one or more consistency properties as discussed herein. In an aspect, the neural network processor 150 can perform the iterative training of NN weights 260, by looping training of the coordinate-based weighted NN model 220 in view of one or more of the control parameters 230, and one or more of the consistency properties 240. For example, the neural network processor 150 can modify one or more of the weights 222 according to one or more of a control parameter 230 and a tuning parameter 232, and can validate output of the coordinate-based weighted neural network (NN) model 220 according to the consistency properties 240 in each iteration. For example, the neural network processor 150 can keep or modify the weights 222 as modified or generated in a given iteration based on whether the weights satisfy the consistency properties 240. In an aspect, the system can provide corresponding ones of the plurality of second training data sets sequentially to the neural network model over one or more iterations to modify the one or more weights over the one or more iterations. In an aspect, the system can modify, for each of the subsets, the one or more weights according to one or more consistency properties that constrain modification of the one or more weights.

The trained weighted NN blender model 270 can correspond to an output of the neural network processor 150 including the coordinate-based weighted NN model 220 and the weights 222 that satisfy the consistency properties 240. The deployed NN blender model 280 can correspond at least partially in one or more of structure and operation to an instance of the trained weighted NN blender model 270 that is configured to execute at runtime to generate output according to the weights 222 of the coordinate-based weighted NN model 220.

The live probabilistic model outputs 282 can be provided as input to the deployed NN blender model 280 by the neural network processor 150 during runtime of the deployed NN blender model 280, to generate one or more live long-range weather forecasts 284 according to a weather condition represented by a target property as discussed herein. The live long-range weather forecasts 284 can include one or more probabilistic outputs as discussed herein, that each correspond to a given target property.

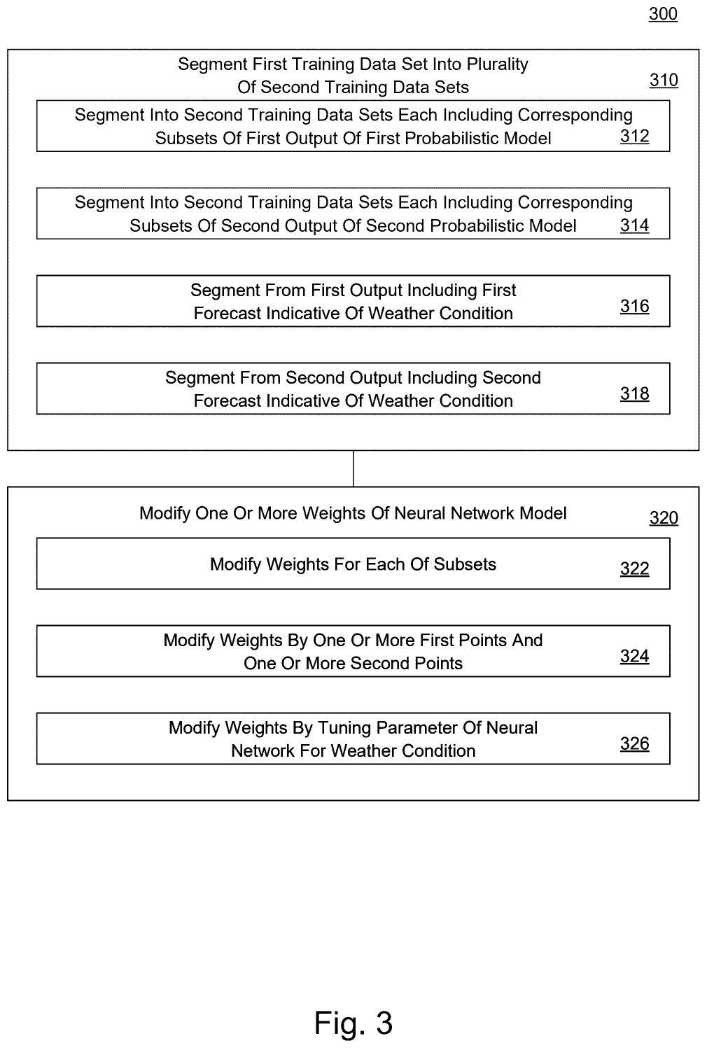

FIG. 3 depicts an example method of multi-model blending via a neural network for probabilistic weather forecasts, according to this disclosure. At least the system 100 or the flow architecture 200 can perform method 300. For example, the method 300 can be implemented using one or more processors executing instructions that are stored in memory of the system. The instructions, upon execution by the one or more processors, can cause the one or more processors to implement any of the operations 310-326 of the method 300 in any sequence or arrangement.

At 310, the method 300 can segment a first training data set into a plurality of second training data sets. This segmentation can be performed by sorting and organizing the input data according to relevant features such as forecast lead time, location, or target property. For example, the training data set can be divided into subsets based on shared spatial coordinates or time intervals to facilitate more targeted and granular blending by the downstream neural network model.

In an aspect of the method, the first probabilistic model has a first probabilistic configuration, and the second probabilistic model has a second probabilistic configuration distinct from the first probabilistic configuration. The first and second probabilistic models can use different modeling approaches, such as a numerical weather prediction model versus a statistical weather model, resulting in distinct output structures or methods of representation. This distinction enables the system to benefit from the complementary strengths of different model types when generating blended forecasts.

At 312, the method 300 can segment into second training data sets each including corresponding subsets of a first output of a first probabilistic model. This operation can include extracting the relevant output values or probabilistic distributions generated by the first probabilistic model, mapped to specific times and locations as defined by the segmentation criteria. For instance, each subset can group together quantile forecasts from the first probabilistic model for all training instances associated with a given geographic grid point. For example, the first probabilistic model generates output structured according to at least one of a quantile, a cumulative distribution, or a probability distribution. For example, the first probabilistic model corresponds to at least one of a numerical weather prediction model, a weather emulator model, or a statistical weather model. For example, the first probabilistic model can use physically based calculations from numerical weather prediction, such as simulations of atmospheric conditions over a grid. The model can be based on a statistical approach or use machine learning techniques to generate probabilistic forecasts based on historical data.

At 314, the method 300 can segment into second training data sets each including corresponding subsets of a second output of a second probabilistic model. This segmentation can be achieved by matching the outputs from the second probabilistic model with the same segmentation scheme used for the first model, ensuring temporal and spatial alignment between corresponding subsets. For example, for each location and forecast lead time, the output from the second probabilistic model can be grouped alongside the output from the first model for direct comparison or blending.

In an aspect of the method, the second probabilistic model corresponds to at least one of a numerical weather prediction model, a weather emulator model, or a statistical weather model. The second probabilistic model may operate based on a different data source or employ an alternative modeling framework, such as a machine learning-based weather emulator trained on reforecast data. This diversity between models allows the system to draw on multiple predictive philosophies, potentially improving the robustness of the blended output.

In an aspect of the method, the second probabilistic model generates output structured according to at least one of a quantile, a cumulative distribution, or a probability distribution. The output of the second model can be formatted as a set of quantiles at specified probability levels or as a complete probabilistic distribution, supporting advanced blending operations.

At 316, the method 300 can segment from first output including a first forecast indicative of a weather condition. This can include extracting the value or probabilistic description of a target weather variable, such as temperature, precipitation, or humidity, as predicted by the first model. For example, the system can isolate the subset of the first model's output corresponding to daily maximum temperature at a particular grid point and time.

At 318, the method 300 can segment from second output including a second forecast indicative of the weather condition. This can include gathering the corresponding forecast values or probabilistic outputs from the second probabilistic model so that they align with the forecasts produced by the first model for the same location and time period. For instance, the system can pair the predicted probability distribution for precipitation generated by the second model with the first model's output for direct input into the blending process.

In an aspect, the method can include correlating, into the first training data set, a third output corresponding to ground truth for the weather condition, the third output can include one or more values of a target property corresponding to a feature of the neural network model. In an aspect, the method can include providing corresponding ones of the plurality of second training data sets sequentially to the neural network model over one or more iterations to modify the one or more weights over the one or more iterations.

At 320, the method 300 can modify one or more weights of the neural network model. In an aspect of the method, the one or more weights are provided responsive to a control parameter satisfying a threshold indicative of a level of alignment with a training data set can include the one or more first training points and the one or more second training points. The adjustment of the weights can be performed during training in order to improve the ability of the neural network to blend outputs from multiple probabilistic models. This modification can involve using iterative optimization techniques, such as gradient descent, to minimize a loss function based on forecast performance.

At 322, the method 300 can modify the weights for each of the subsets. For example, these per-subset adjustments can allow the neural network to assign different blending weights based on varying characteristics, such as region, forecast period, or climatological regime, facilitating the contribution of each probabilistic model to specific situations.

At 324, the method 300 can modify the weights according to the one or more first points and the one or more second points. The first points can represent spatial features, such as geographic coordinates, and the second points can represent temporal features, such as prediction lead time. Modifying the weights in this context allows the neural network to dynamically adjust its blending strategy based on both where (e.g., location or spatial aspect), as well as when (e.g., time or temporal aspects) of applying the forecast.

At 326, the method 300 can modify the weights according to a tuning parameter of the neural network for the weather condition. The tuning parameter can correspond to factors such as seasonality, extreme weather event occurrence, or inherent uncertainty of the predicted variable. By including this parameter, the neural network can better capture context-dependent behavior and further improve the reliability of its blended forecast.

In an aspect of the method, the tuning parameter corresponds to at least one of location, forecast lead time, or season, and the weather condition corresponds to a forecast lead time greater than two weeks. In an aspect, the method can include modifying, for each of the subsets, the one or more weights according to one or more consistency properties that constrain modification of the one or more weights. In an aspect of the method, the consistency properties are structured to enforce non-crossing of quantile levels. In an aspect of the method, the consistency properties are structured to enforce normalization of each of the one or more weights to aggregate to a predetermined scalar value. In an aspect of the method, the one or more consistency properties constrain modification of the one or more weights for each of the subsets.

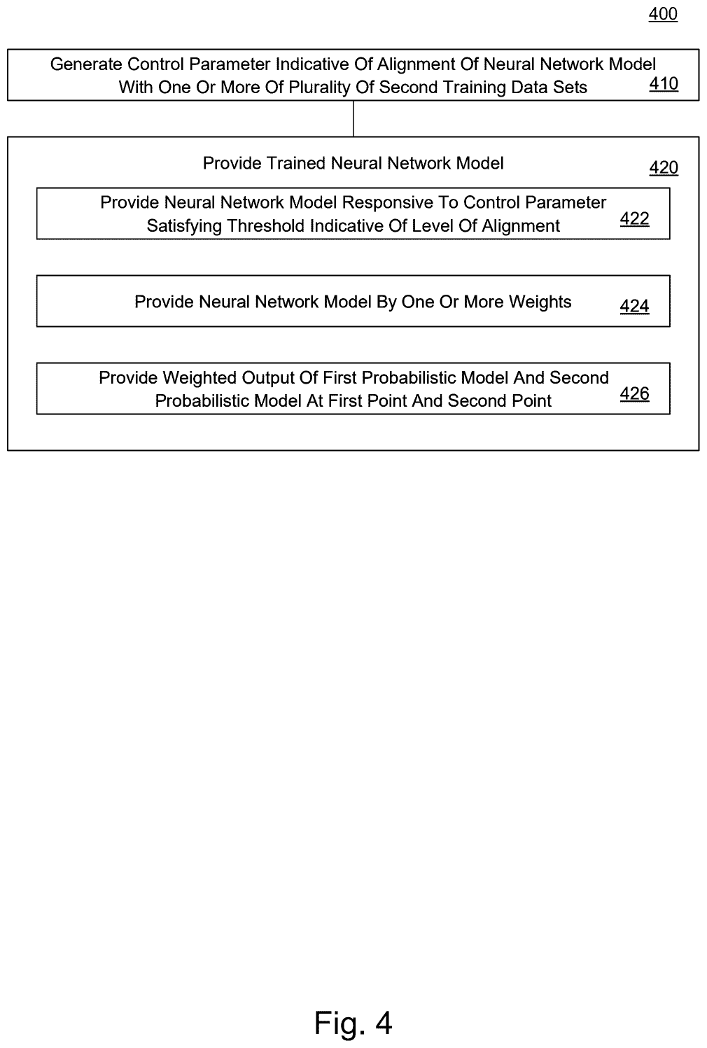

FIG. 4 depicts an example method of multi-model blending via a neural network for probabilistic weather forecasts, according to this disclosure. At least the system 100 or any component thereof can perform method 400. For example, the method 400 can be implemented using one or more processors executing instructions that are stored in memory of the system. The instructions, upon execution by the one or more processors, can cause the one or more processors to implement any of the operations 410-426 of the method 400 in any sequence or arrangement.

At 410, the method 400 can generate a control parameter indicative of alignment of the neural network model with one or more of the plurality of second training data sets. In an aspect, the method can include determining that the control parameter satisfies the threshold according to a target property indicative of the weather condition, the target property corresponding to a feature of the neural network model.

At 420, the method 400 can provide the trained neural network model. Providing the trained model can involve saving its state for deployment in operational forecasting environments or for further refinement if additional data becomes available. The provision of the trained model makes it possible to produce new forecasts based on real-time or future probabilistic model outputs.

At 422, the method 400 can provide the neural network model responsive to the control parameter satisfying a threshold indicative of the level of alignment. When the control parameter meets or exceeds the threshold, it can indicate that the neural network model is sufficiently calibrated to generate reliable blended forecasts. As a result, only models that demonstrate acceptable performance are used in downstream forecasting applications.

At 424, the method 400 can provide the neural network model according to the one or more weights. These weights can reflect how the model has learned to combine outputs from the constituent probabilistic models under various conditions. The availability of these weights can allow for the blending model to adaptively generate forecasts based on contextual features such as location or season.

At 426, the method 400 can provide a weighted output of the first probabilistic model and the second probabilistic model at the first point and the second point. The weighted output can represent a probabilistic forecast synthesized from both models, leveraging strengths of each source for the specific spatial and temporal context. This can support improved forecast accuracy and consistency across a range of lead times and geographic settings.

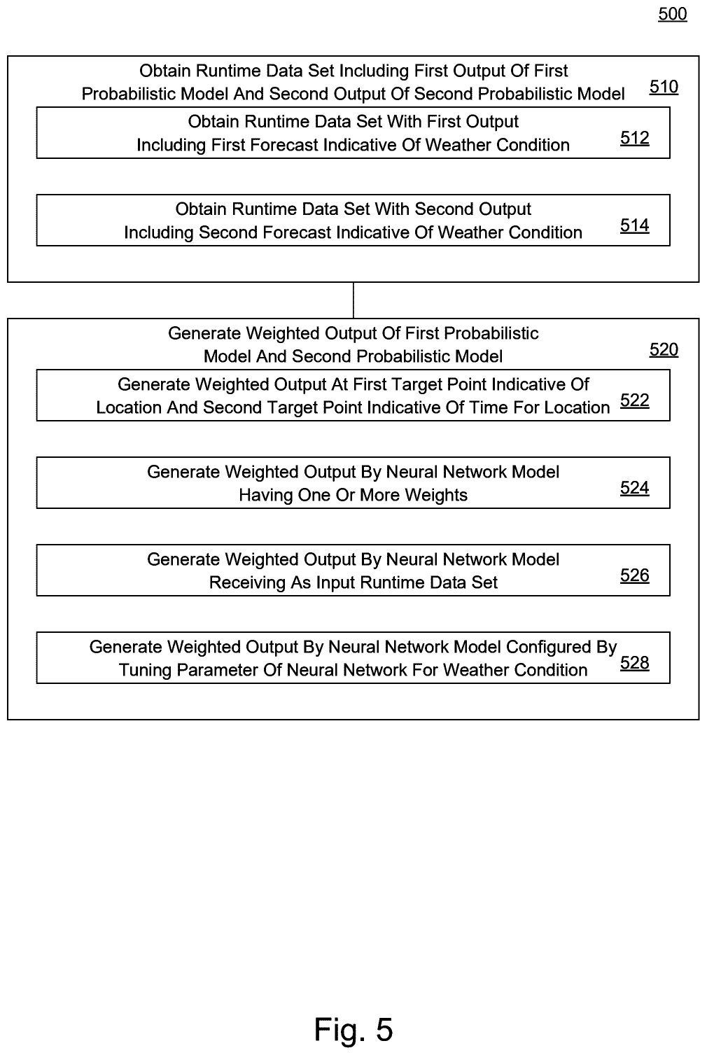

FIG. 5 depicts an example method of multi-model blending via a neural network for probabilistic weather forecasts, according to this disclosure. At least the system 100 or any component thereof can perform method 500. For example, the method 500 can be implemented using one or more processors executing instructions that are stored in memory of the system. The instructions, upon execution by the one or more processors, can cause the one or more processors to implement any of the operations 510-528 of the method 500 in any sequence or arrangement.

At 510, the method 500 can obtain a runtime data set including a first output of a first probabilistic model and a second output of a second probabilistic model. This runtime data set can be collected during operational use, using the most recent available forecasts from each probabilistic model. Gathering both outputs allows the system to utilize real-time information for generating up-to-date and context-relevant blended forecasts.

At 512, the method 500 can obtain the runtime data set with the first output including a first forecast indicative of the weather condition. This runtime data set can be collected during operational use, using the most recent available forecasts from each probabilistic model. Gathering both outputs allows the system to utilize real-time information for generating up-to-date and context-relevant blended forecasts.

At 514, the method 500 can obtain the runtime data set with the second output including a second forecast indicative of the weather condition. The second output can be matched for the same target property and context as the first, ensuring compatibility in blending. By using both outputs, the system can combine information from different modeling approaches to produce a more robust probabilistic forecast.

At 520, the method 500 can generate a weighted output of the first probabilistic model and the second probabilistic model. The weighted output can reflect the learned importance (e.g., level of importance or value) of each model's prediction as determined during training. This can allow for the system to produce an aggregate forecast that leverages the strengths of each of the plurality of constituent models.

At 522, the method 500 can generate the weighted output at a first target point indicative of a location and a second target point indicative of a time for the location. This can allow the blended forecast to be specifically tailored for a particular place and forecast period, thereby improving the local accuracy (e.g., spatially and temporally) for a given forecast.

At 524, the method 500 can generate the weighted output according to a neural network model having one or more weights. The neural network model applies these weights to the incoming forecast information, combining model outputs in a context-dependent fashion. This adaptive blending can improve forecast skill by adjusting to the unique characteristics of each situational context.

At 526, the method 500 can generate the weighted output according to a neural network model receiving as input the runtime data set. By ingesting the latest available probabilistic model outputs, the neural network can generate fresh predictions for each new cycle. The model's structure allows it to interpret and combine incoming data sources dynamically and efficiently.

At 528, the method 500 can generate the weighted output according to a neural network model configured according to a tuning parameter of the neural network for the weather condition. The tuning parameter can modify model behavior to account for factors such as seasonality or forecast lead time, enabling more precise forecasts.

In an aspect of the methods 300-500, the first probabilistic model has a first probabilistic configuration, and the second probabilistic model has a second probabilistic configuration distinct from the first probabilistic configuration. In an aspect of the methods 300-500, the first probabilistic model corresponds to at least one of a numerical weather prediction model, a weather emulator model, or a statistical weather model, and the second probabilistic model corresponds to at least one of the numerical weather prediction model, the weather emulator model, or the statistical weather model.

Having now described some illustrative implementations, the foregoing is illustrative and not limiting, having been presented by way of example. In particular, although many of the examples presented herein involve specific combinations of method acts or system elements, those acts and those elements may be combined in other ways to accomplish the same objectives. Acts, elements and features discussed in connection with one implementation are not intended to be excluded from a similar role in other implementations.

The phraseology and terminology used herein is for the purpose of description and should not be regarded as limiting. The use of “including,” “comprising,” “having,” “containing,” “involving,” “characterized by,” “characterized in that,” and variations thereof herein, is meant to encompass the items listed thereafter, equivalents thereof, and additional items, as well as alternate implementations consisting of the items listed thereafter exclusively. In one implementation, the systems and methods described herein consist of one, each combination of more than one, or all of the described elements, acts, or components.

References to “or” may be construed as inclusive so that any terms described using “or” may indicate any of a single, more than one, and all of the described terms. References to at least one of a conjunctive list of terms may be construed as an inclusive OR to indicate any of a single, more than one, and all of the described terms. For example, a reference to “at least one of ‘A’ and ‘B’” can include only ‘A’, only ‘B’, as well as both ‘A’ and ‘B’. Such references used in conjunction with “comprising” or other open terminology can include additional items. References to “is” or “are” may be construed as nonlimiting to the implementation or action referenced in connection with that term. The terms “is” or “are” or any tense or derivative thereof, are interchangeable and synonymous with “can be” as used herein, unless stated otherwise herein.

Directional indicators depicted herein are example directions to facilitate understanding of the examples discussed herein, and are not limited to the directional indicators depicted herein. Any directional indicator depicted herein can be modified to the reverse direction, or can be modified to include both the depicted direction and a direction reverse to the depicted direction, unless stated otherwise herein. While operations are depicted in the drawings in a particular order, such operations are not required to be performed in the particular order shown or in sequential order, and all illustrated operations are not required to be performed. Actions described herein can be performed in a different order. Where technical features in the drawings, detailed description or any claim are followed by reference signs, the reference signs have been included to increase the intelligibility of the drawings, detailed description, and claims. Accordingly, neither the reference signs nor their absence have any limiting effect on the scope of any claim elements.

Scope of the systems and methods described herein is thus indicated by the appended claims, rather than the foregoing description. The scope of the claims includes equivalents to the meaning and scope of the appended claims.

1. A system, comprising:
one or more processors, coupled with memory, to:
segment a first training data set into a plurality of second training data sets each including subsets of a first output of a first probabilistic model and a second output of a second probabilistic model, the first output including a first forecast indicative of a weather condition, and the second output including a second forecast indicative of the weather condition;
provide, to a neural network model, a first point of each of the plurality of second training data sets and a second point of each of the plurality of second training data sets, the first point indicative of the weather condition at a location, and the second point indicative of the weather condition at a time corresponding to the location;
modify, for each of the subsets, one or more weights of a neural network model according to the one or more first points, the one or more second points, and a tuning parameter of the neural network corresponding to the weather condition;
generate a control parameter indicative of alignment of the neural network model with one or more of the plurality of second training data sets; and
provide, responsive to the control parameter satisfying a threshold indicative of a level of alignment with the plurality of second training data sets, the neural network model trained to generate, according to the one or more weights, a weighted output of the first probabilistic model and the second probabilistic model at the first point and the second point.

2. The system of claim 1, comprising the one or more processors to:
determine that the control parameter satisfies the threshold according to a target property indicative of the weather condition, the target property corresponding to a feature of the neural network model.

3. The system of claim 1, wherein the tuning parameter is configured to modify at least one weight of at least one connection between a first neuron and a second neuron, based at least partially on a relative weight of one or more probabilistic models provided as input to at least one of the first neuron or the second neuron.

4. The system of claim 1, wherein the tuning parameter corresponds to at least one of location, forecast lead time, or season, and the weather condition corresponds to a forecast lead time greater than two weeks.

5. The system of claim 1, wherein the first probabilistic model has a first probabilistic configuration, and the second probabilistic model has a second probabilistic configuration distinct from the first probabilistic configuration.

6. The system of claim 5, wherein the first probabilistic model corresponds to at least one of a numerical weather prediction model, a weather emulator model, or a statistical weather model.

7. The system of claim 5, wherein the second probabilistic model corresponds to at least one of a numerical weather prediction model, a weather emulator model, or a statistical weather model.

8. The system of claim 5, wherein the first probabilistic model generates output structured according to at least one of a quantile, a cumulative distribution, or a probability distribution.

9. The system of claim 5, wherein the second probabilistic model generates output structured according to at least one of a quantile, a cumulative distribution, or a probability distribution.

10. The system of claim 1, comprising the one or more processors to:
correlate, into the first training data set, a third output corresponding to ground truth for the weather condition, the third output including one or more values of a target property corresponding to a feature of the neural network model.

11. The system of claim 1, comprising the one or more processors to:
provide corresponding ones of the plurality of second training data sets sequentially to the neural network model over one or more iterations to modify the one or more weights over the one or more iterations.

12. The system of claim 1, comprising the one or more processors to:
modify, for each of the subsets, the one or more weights according to one or more consistency properties that constrain modification of the one or more weights.

13. The system of claim 12, wherein the consistency properties are structured to enforce non-crossing of quantile levels.

14. The system of claim 12, wherein the consistency properties are structured to enforce normalization of each of the one or more weights to aggregate to a predetermined scalar value.

15. The system of claim 12, wherein the one or more consistency properties constrain modification of the one or more weights for each of the subsets.

16.-20. (canceled)

21. A method, comprising:
segmenting a first training data set into a plurality of second training data sets each including subsets of a first output of a first probabilistic model and a second output of a second probabilistic model, the first output including a first forecast indicative of a weather condition, and the second output including a second forecast indicative of the weather condition;
providing, to a neural network model, a first point of each of the plurality of second training data sets and a second point of each of the plurality of second training data sets, the first point indicative of the weather condition at a location, and the second point indicative of the weather condition at a time corresponding to the location;
modifying, for each of the subsets, one or more weights of a neural network model according to the one or more first points, the one or more second points, and a tuning parameter of the neural network corresponding to the weather condition;
generating a control parameter indicative of alignment of the neural network model with one or more of the plurality of second training data sets; and
providing, responsive to the control parameter satisfying a threshold indicative of a level of alignment with the plurality of second training data sets, the neural network model trained to generate, according to the one or more weights, a weighted output of the first probabilistic model and the second probabilistic model at the first point and the second point.

22. The method of claim 21, further comprising:
determining that the control parameter satisfies the threshold according to a target property indicative of the weather condition, the target property corresponding to a feature of the neural network model.

23. The method of claim 21, wherein the tuning parameter is configured to modify at least one weight of at least one connection between a first neuron and a second neuron, based at least partially on a relative weight of one or more probabilistic models provided as input to at least one of the first neuron or the second neuron.

24. The method of claim 21, wherein the tuning parameter corresponds to at least one of location, forecast lead time, or season, and the weather condition corresponds to a forecast lead time greater than two weeks.

25. The method of claim 21, wherein the first probabilistic model has a first probabilistic configuration, and the second probabilistic model has a second probabilistic configuration distinct from the first probabilistic configuration.

26.-40. (canceled)
